(19) United States
(12) Patent Application Publication
(10) Pub. No.: US 2026/0311303 A1
(43) Pub. Date: Oct. 8, 2026

(54) INTEGRATION OF IMAGE ENHANCEMENT MODELS FOR EXTENDED REALITY (XR) OR OTHER APPLICATIONS

(71) Applicant: Samsung Electronics Co., Ltd., Suwon-si (KR)

(72) Inventors: Yingen Xiong, Mountain View, CA (US); Shijun Liang, East Lansing, MI (US); Christopher A. Peri, Mountain View, CA (US)

(21) Appl. No.: 19/578,639

(22) Filed: Mar. 25, 2026

Related U.S. Application Data
(60) Provisional application No. 63/785,378, filed on Apr. 8, 2025.

(51) Int. Cl. G06T 5/70; G06T 5/77; G06T 7/00

(52) U.S. Cl. CPC G06T 5/70; G06T 5/77; G06T 7/0002; G06T 2207/20004; G06T 2207/30168

(57) ABSTRACT

A method includes obtaining, using at least one processing device of an electronic device, an image frame and determining, using the at least one processing device, one or more light conditions associated with the image frame. The method also includes determining, using the at least one processing device, whether the one or more light conditions are acceptable. The method further includes performing, using the at least one processing device, at least one of low-light denoising or brightness enhancement to generate an enhanced image frame in response to determining that the one or more light conditions are not acceptable. In addition, the method includes rendering, using the at least one processing device, the enhanced image frame for display.

### CROSS-REFERENCE TO RELATED APPLICATION AND PRIORITY CLAIM

This application claims priority under 35 U.S.C. § 119 (e) to U.S. Provisional Patent Application No. 63/785,378 filed on Apr. 8, 2025, which is hereby incorporated by reference in its entirety.

### TECHNICAL FIELD

This disclosure relates generally to image processing systems. More specifically, this disclosure relates to integration of image enhancement models for extended reality (XR) or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to integration of image enhancement models for extended reality (XR) or other applications.

In a first embodiment, a method includes obtaining, using at least one processing device of an electronic device, an image frame and determining, using the at least one processing device, one or more light conditions associated with the image frame. The method also includes determining, using the at least one processing device, whether the one or more light conditions are acceptable. The method further includes performing, using the at least one processing device, at least one of low-light denoising or brightness enhancement to generate an enhanced image frame in response to determining that the one or more light conditions are not acceptable. In addition, the method includes rendering, using the at least one processing device, the enhanced image frame for display.

In a second embodiment, an electronic device includes at least one processing device configured to obtain an image frame, determine one or more light conditions associated with the image frame, and determine whether the one or more light conditions are acceptable. The at least one processing device is also configured to perform at least one of low-light denoising or brightness enhancement to generate an enhanced image frame in response to determining that the one or more light conditions are not acceptable. In addition, the at least one processing device is configured to render the enhanced image frame for display.

In a third embodiment, a non-transitory machine readable medium contains instructions that when executed cause at least one processor of an electronic device to obtain an image frame, determine one or more light conditions associated with the image frame, and determine whether the one or more light conditions are acceptable. The non-transitory machine readable medium also contains instructions that when executed cause the at least one processor to perform at least one of low-light denoising or brightness enhancement to generate an enhanced image frame in response to determining that the one or more light conditions are not acceptable. In addition, the non-transitory machine readable medium contains instructions that when executed cause the at least one processor to render the enhanced image frame for display.

Any one or any combination of the following features may be used with the first, second, or third embodiment.

A passthrough transformation of the image frame may be performed to generate a transformed image frame, and the transformed image frame may be rendered for display in response to determining that the one or more light conditions are acceptable. At least one of the low-light denoising or the brightness enhancement may be performed using the transformed image frame in response to determining that the one or more light conditions are not acceptable.

At least one of the low-light denoising or the brightness enhancement may be performed by selecting at least one image enhancement model; determining at least one parameter for the at least one image enhancement model; integrating the at least one image enhancement model with the at least one parameter to generate at least one integrated image enhancement model; and performing low-light enhancement using the at least one integrated image enhancement model.

The at least one image enhancement model may be selected by selecting at least one of: an exponential image enhancement model and exposure ratio map for local image enhancement; an adaptive gamma correction model with a gamma coefficient for global image enhancement; or an adaptive affine correction model with gain and bias parameters for global image enhancement.

In response to selection of two or more of the image enhancement models, the two or more image enhancement models may be integrated.

The at least one parameter may include at least one of: multiple camera parameters, a gamma coefficient for gamma correction, or a gain and a bias for an affine correction.

The at least one image enhancement model may be integrated with the at least one parameter by integrating the at least one parameter with a camera model to generate an estimated camera model; integrating the estimated camera model with the at least one image enhancement model to generate the at least one integrated image enhancement model; and optimizing the at least one integrated image enhancement model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resonance imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for generating enhanced output image frames through integration of image enhancement models in accordance with this disclosure;

FIG. 3 illustrates another example process for generating enhanced output image frames through integration of image enhancement models in accordance with this disclosure;

FIG. 4 illustrates an example process for estimating an image enhancement model to be applied to an input image frame in accordance with this disclosure;

FIG. 5 illustrates an example process for estimating parameters for use with an image enhancement model in accordance with this disclosure;

FIG. 6 illustrates an example process for optimizing an illumination map in accordance with this disclosure;

FIG. 7 illustrates an example process for enhancing an input image frame using an integrated image enhancement model in accordance with this disclosure; and

FIG. 8 illustrates an example method for integration of image enhancement models for extended reality (XR) or other applications in accordance with this disclosure.

### DETAILED DESCRIPTION

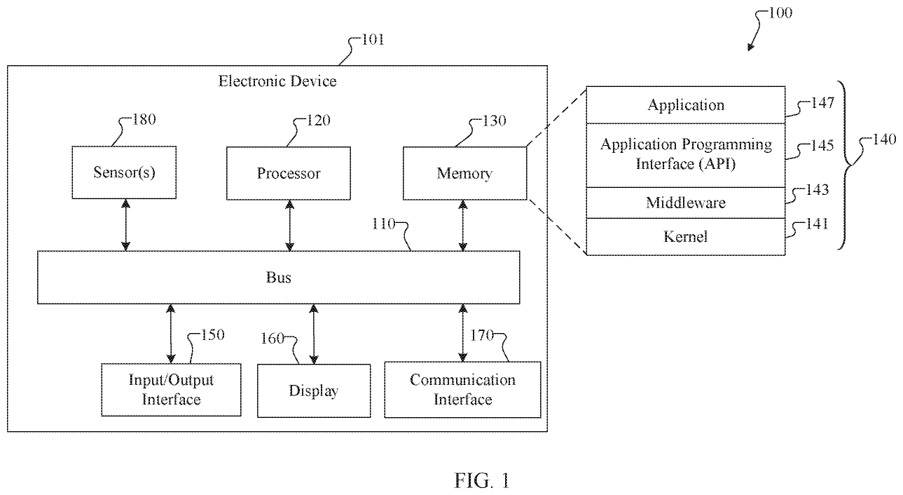

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Video see-through (VST) XR systems (also called “passthrough” XR systems) present users with generated video sequences of real-world scenes and can be built using virtual reality (VR) technologies. A VST XR device often includes one or more imaging sensors (also called “see-through cameras”) that capture high-resolution image frames of a user's surrounding environment. These image frames are processed in an image processing pipeline in order to generate final rendered views of the user's surrounding environment.

Providing high visual quality of image frames or other XR content is often necessary or desirable to allow a user to feel comfortable while using a VST or OST headset device or other device. For example, image quality can be an important factor in providing a high-quality user experience because it allows the user to perceive his or her surroundings more clearly. Image quality can be dependent on image frames or other content having proper contrast and brightness. However, low-light environments or other environments can make it difficult to provide proper contrast and brightness for displayed content.

This disclosure provides various techniques related to integration of image enhancement models for XR or other applications. As described in more detail below, an image frame may be obtained, and one or more light conditions associated with the image frame may be determined. A determination can be made whether the one or more light conditions are acceptable. If not, low-light denoising and/or brightness enhancement may be performed to generate an enhanced image frame. In some cases, at least one image enhancement model can be selected, and at least one parameter can be determined for the at least one image enhancement model. The at least one image enhancement model can be integrated with the at least one parameter to generate at least one integrated image enhancement model, and low-light enhancement can be performed using the at least one integrated image enhancement model. The at least one selected image enhancement model could include at least one of an exponential image enhancement model and exposure ratio map for local image enhancement, an adaptive gamma correction model with a gamma coefficient for global image enhancement, or an adaptive affine correction model with gain and bias parameters for global image enhancement. In response to selection of two or more of the image enhancement models, the two or more image enhancement models can be integrated. The at least one image enhancement model could be integrated with the at least one parameter by integrating the at least one parameter with a camera model to generate an estimated camera model, integrating the estimated camera model with the at least one image enhancement model to generate the at least one integrated image enhancement model, and optimizing the at least one integrated image enhancement model. The enhanced image frame may be rendered for display.

In this way, the disclosed techniques enable improved image processing using integration of image enhancement models for enhancing brightness and contrast and reducing noise in image frames, which can improve visual quality of the image frames. For example, image frames captured in low-light environments often suffer from a lack of contrast and brightness and are visually noisy. Directly rendering low-light image frames to one or more display panels of an electronic device for viewing by a user may impair the user's experience. The disclosed techniques can improve brightness, contrast, and visual quality of low-light image frames and can reduce noise in the low-light image frames. As a result, output image frames that are generated can be clearer, brighter, and more visually-appealing to the user. Note that while the disclosed techniques may often be described below in the context of VST XR devices, the disclosed techniques may be used with any other suitable electronic devices. For example, the disclosed techniques may be used with OST XR devices.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to integration of image enhancement models for XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform integration of image enhancement models for XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to integration of image enhancement models for XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

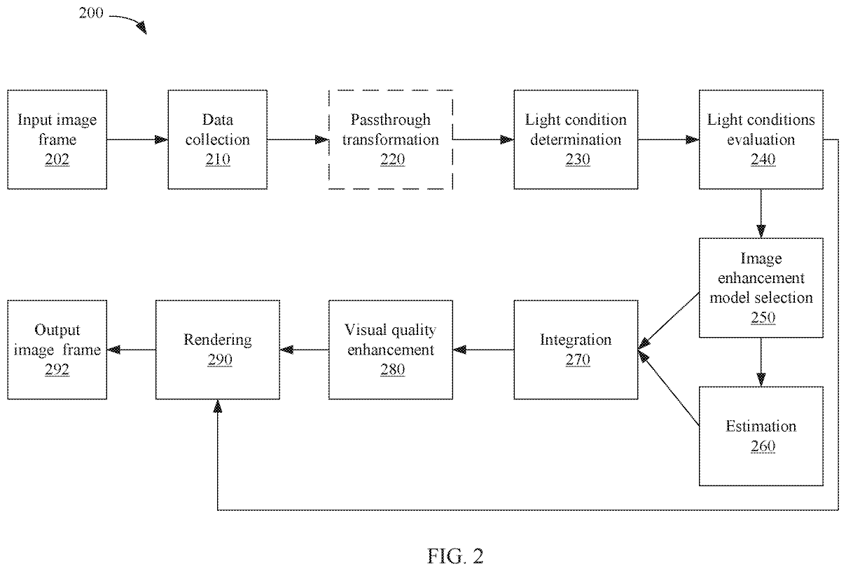

FIG. 2 illustrates an example process 200 for generating enhanced output image frames through integration of image enhancement models in accordance with this disclosure. For ease of explanation, the process 200 shown in FIG. 2 is described as being performed using the electronic device 101 shown in FIG. 1. However, the process 200 shown in FIG. 2 may be performed using any other suitable device(s) (such as the server 106) and in any other suitable system(s).

As shown in FIG. 2, the process 200 includes a data collection operation 210, which generally operates to obtain input image frames 202 to be processed. For example, the data collection operation 210 could obtain high-resolution color image frames or other image frames 202 captured using one or more see-through color cameras or other imaging sensors 180 of the electronic device 101. The data collection operation 210 can obtain any suitable number of image frames 202. In some cases, the process 200 may receive image frames 202 at a specified frame rate, such as 30, 60, 90, or 120 frames per second. The image frames 202 may also be obtained from any suitable number of imaging sensors 180, such as from left and right see-through cameras. Further, each image frame 202 can have any suitable size, shape, and resolution and include image data in any suitable domain. As particular examples, each image frame 202 may include RGB image data, YUV image data, or Bayer or other raw image data. In addition, different image frames 202 capturing the same scene could have the same exposure or different exposures.

The data collection operation 210 may optionally obtain other information to be processed. For example, the data collection operation 210 could be used to obtain depth data from one or more depth sensors 180, head poses from one or more positional sensors 180, and eye tracking data from one or more eye tracking sensors 180. The depth data may generally represent measurements or estimates of the depths within a scene, meaning distances between the electronic device 101 and various points within the scene being imaged. The depth data may be obtained using any suitable sensor(s) 180, such as one or more time-of-flight (ToF) sensors, light detection and ranging (LiDAR) sensors, or stereo vision sensors.

The head pose data may represent measurements or estimates of the pose of a user's head while the electronic device 101 is being used. In some cases, the head pose data may be expressed using six degrees of freedom, such as three translation values identifying movement of the user's head along three orthogonal axes and three rotation values identifying rotation of the user's head about the three orthogonal axes. The head pose data may be obtained using any suitable sensor(s) 180, such as from one or more IMUs.

The eye tracking data can include image frames capturing the user's left and right eyes. The eye tracking data may be obtained using any suitable sensor(s) 180, such as from one or more eye pose tracking cameras. The eye pose tracking cameras can represent high-resolution cameras that capture image frames of the user's eyes during illumination by one or more infrared or other illuminators (like one or more light emitting diodes) of the electronic device 101.

A passthrough transformation operation 220 generally operates to apply one or more transformations to the image frames 202, such as to transform image data from viewpoints of imaging sensors 180 to viewpoints of a user's eyes. Note that the passthrough transformation operation 220 here is optional or could be performed at other points within the process 200. In some cases, the passthrough transformation operation 220 may perform at least one static passthrough transformation and at least one dynamic passthrough transformation. A static transformation may not depend on the contents of the image frames 202 being processed and could be based on the components of the electronic device 101 and/or the configuration of the components of the electronic device 101. A dynamic transformation can vary based on the contents of the image frames 202 being processed.

In some embodiments, the static transformations can include a camera undistortion transformation and/or a display geometric distortion calibration (GDC)/chromatic aberration correction (CAC) transformation. A camera undistortion transformation can be used to correct for lens distortions in captured image frames 202 caused by one or more lenses of one or more imaging sensors 180 used to capture the image frames 202. A display GDC/CAC transformation can be used to pre-compensate image frames for expected geometric distortions and chromatic aberrations created when rendered images are displayed and viewed through display lenses of the electronic device 101. Also, in some cases, the dynamic transformations can include a time warp reprojection, a planar reprojection, or a depth-based reprojection. A time warp reprojection generally refers to a reprojection of image data from one image frame to another, where the image data is generally within a common plane in both image frames. A planar reprojection generally refers to a reprojection of image data onto a single plane, such as when all background image content is reprojected to a single plane at a single specified depth from the electronic device 101. A depth-based reprojection generally refers to a reprojection of image data based on depths associated with the image data. Each transformation may be implemented in any suitable manner, such as by warping or otherwise modifying one or more image frames 202 using one or more distortion meshes to achieve the desired correction(s).

A light condition determination operation 230 generally operates to determine one or more light conditions associated with each image frame 202 or transformed version thereof. For example, the light condition determination operation 230 could be used to determine the brightness (luminance) of each image frame 202 and/or the contrast of each image frame 202. The light condition determination operation 230 may also determine one or more criteria for evaluating an image quality of each image frame 202. Example details of how the light condition determination operation 230 may be implemented are provided below.

A light condition evaluation operation 240 generally operates to evaluate the image quality of each image frame 202 or transformed version thereof. For example, the light condition evaluation operation 240 may use the one or more light conditions (such as brightness and/or contrast) and the one or more criteria as identified by the light condition determination operation 230 to determine whether the one or more light conditions for each image frame 202 are acceptable. If not, this can be indicative that the image frame 202 is a low-light image frame or otherwise captures a darker scene. Thus, for instance, an image frame 202 may be acceptable if its brightness and/or contrast satisfy one or more criteria, such as one or more acceptable brightness and contrast thresholds. If it is determined that an image frame 202 is acceptable, a rendering operation 290 can be performed to produce an output image frame 292. Otherwise, if it is determined that an image frame 202 is not acceptable, low-light denoising and/or visual quality enhancement can be performed before the rendering operation 290. Example details of how the light condition evaluation operation 240 may be implemented are provided below.

An image enhancement model selection operation 250 generally operates to select at least one image enhancement model to be applied to at least one image frame 202 or transformed version thereof. For example, the image enhancement model selection operation 250 could select an appropriate image enhancement model for each low-light image frame based on the one or more evaluated light conditions. As a particular example, the image enhancement model selection operation 250 could select an image enhancement model that best fits a desired enhancement of an image frame 202 from among a set of predefined models, such as based on the determined and evaluated light condition(s) for that image frame 202. Examples of predefined image enhancement models that could be used here may include an exponential model (which may employ one or more camera parameters and an exposure ratio), an adaptive gamma correction model (which may employ a gamma coefficient), and an adaptive affine correction model (which may employ one or more parameters for one or more of gain and bias). Example details of how the image enhancement model selection operation 250 may be implemented are provided below.

An estimation operation 260 generally operates to estimate one or more model parameters for the generated image enhancement model and/or one or more image maps (such as an optimized illumination map) for the generated image enhancement model. For example, the estimation operation 260 may estimate one or more model parameters for the generated image enhancement model so that the image enhancement model (as modified to include the one or more model parameters) can be applied to enhance at least one image frame 202 or transformed version thereof. In some embodiments, at least one of the one or more parameters can be estimated according to one or more properties of the imaging sensor 180 used to capture an image frame 202 and one or more light conditions of the image frame 202. In some cases, a camera model could be estimated, where the camera model corresponds to the imaging sensor 180. Example details of how the estimation operation 260 may be implemented are provided below.

An integration operation 270 generally operates to integrate the image enhancement model generated by the image enhancement model selection operation 250 and the one or more model parameters estimated by the estimation operation 260. For example, the integration operation 270 could integrate the one or more estimated model parameters and the estimated and/or generated image enhancement model corresponding to an imaging sensor 180 in order to generate at least one integrated image enhancement model, which can subsequently be applied to one or more image frames 202 captured using that imaging sensor 180 (or transformed versions thereof). In some cases, the integration operation 270 could incorporate at least one image map (such as an estimated exposure ratio map) from the estimation operation 260 with the selected image enhancement model and integrate a camera brightness transform function with the selected image enhancement model. Example details of how the integration operation 270 may be implemented are provided below.

A visual quality enhancement operation 280 generally operates to apply each integrated image enhancement model from the integration operation 270 to one or more image frames 202 or transformed versions thereof. This results in the generation of one or more enhanced image frames. For example, the visual quality enhancement operation 280 can apply at least one integrated image enhancement model from the integration operation 270 to the image frames 202 in order to generate enhanced image frames, where the application of the model(s) may compensate for low-light conditions in the image frames 202. In some cases, the visual quality enhancement operation 280 can verify an enhanced image frame using one or more image quality parameters, finalize the enhanced image frame according to the verification result for color consistency (such as with a global enhancement function), and verify image quality of the enhanced image frame. As a particular example, the verification could include determining a signal-to-noise ratio (SNR) of the enhanced image frame, comparing the SNR against a threshold, and performing noise reduction if the SNR fails to exceed the threshold. Example details of how the visual quality enhancement operation 280 may be implemented are provided below.

In this example, each enhanced image frame (or non-enhanced image frame if enhancement is not performed) may be rendered using the rendering operation 290, resulting in the generation of a corresponding output image frame 292. For example, the rendering operation 290 may produce output image frames 292 that are suitable for display on one or more display panels, such as one or more displays 160 of the electronic device 101. As a particular example, rendering can include processing image data using rasterization and ray tracing for a scene to simulate light interaction with surfaces in the scene. Rendering can also include any desired post-processing, such as by compositing with additional layers, color correction, visual effect addition, and/or filtering.

Although FIG. 2 illustrates one example of a process 200 for generating enhanced output image frames through integration of image enhancement models, various changes may be made to FIG. 2. For example, various operations or functions in FIG. 2 may be combined, further subdivided, replicated, omitted, or rearranged and additional components or functions may be added according to particular needs.

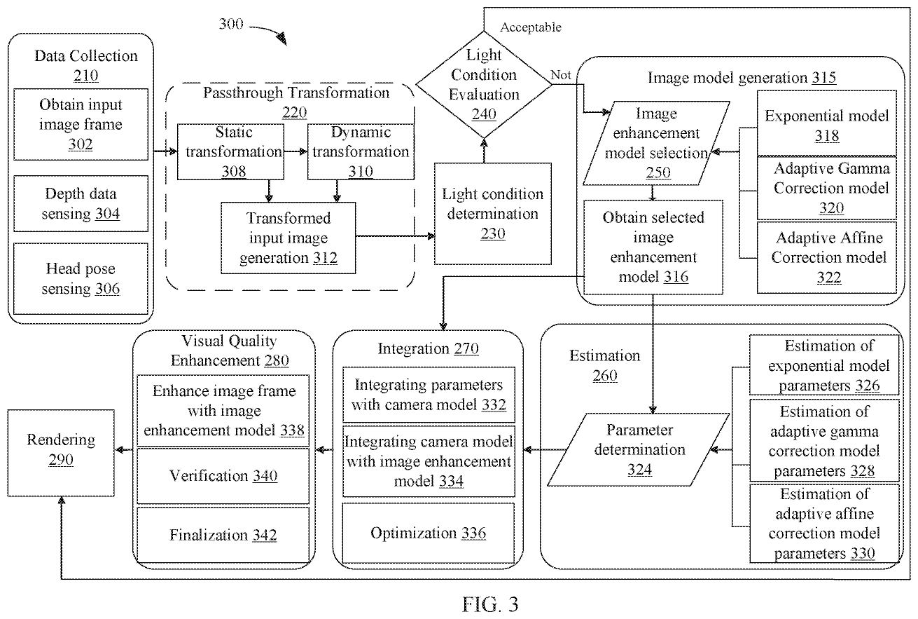

FIG. 3 illustrates another example process 300 for generating enhanced output image frames through integration of image enhancement models in accordance with this disclosure. The process 300 of FIG. 3 may represent a more detailed implementation of the process 200 of FIG. 2. For ease of explanation, the process 300 shown in FIG. 3 is described as being performed using the electronic device 101 shown in FIG. 1. However, the process 300 shown in FIG. 3 may be performed using any other suitable device(s) (such as the server 106) and in any other suitable system(s).

As shown in FIG. 3, the data collection operation 210 can include an obtain image frame function 302, which generally operates to obtain image frames 202. For example, the obtain image frame function 302 may obtain one or more image frames 202 captured using one or more imaging sensors 180. The data collection operation 210 can also include a depth data sensing function 304, which generally operates to obtain depth data associated with the image frame(s) 202. For instance, the depth data sensing function 304 may obtain depth data from one or more depth sensors 180, such as one or more ToF, LiDAR, or stereo vision sensors. In addition, the data collection operation 210 can include a head pose sensing function 306, which generally operates to obtain head pose data. For example, the head pose sensing function 306 may obtain head pose data from one or more IMUs or other position sensors.

The passthrough transformation operation 220 can include a static transformation function 308 and a dynamic transformation function 310, which can be collectively used by a transformed input image generation function 312 to transform the captured image frames 202. For example, the transformed input image generation function 312 can apply the static transformation function 308 to provide one or more static transformations, such as a camera undistortion transformation and/or a GDC/CAC transformation. The transformed input image generation function 312 can apply the dynamic transformation function 310 to provide one or more dynamic transformations, such as a time warp reprojection, a planar reprojection, or a depth-based reprojection. This can result in the generation of transformed versions of the image frames 202. Again, note that the passthrough transformation operation 220 is optional or could be performed at other points within the process 300.

The light condition determination operation 230 can be used to determine one or more light conditions and one or more criteria based on each image frame 202 or transformed version thereof. For example, the light condition determination operation 230 could determine brightness, contrast, SNR, or other or additional measurement(s) associated with each image frame 202. The light condition evaluation operation 240 can be used to determine whether each image frame 202 or transformed version thereof is acceptable based on the light condition(s) and associated criterion/criteria. When it is determined that an image frame 202 or transformed version thereof is acceptable (and therefore likely not a low-light frame), the image frame or transformed version thereof can be rendered using the rendering operation 290.

When it is determined that an image frame 202 or transformed version thereof is not acceptable (and therefore may be a low-light frame), image frame enhancement can be performed. When image frame enhancement is performed, an image enhancement model generation function 315 can be used to generate or otherwise obtain at least one image enhancement model to be applied to the image frame 202. For example, the image enhancement model generation function 315 could select or otherwise obtain an image enhancement model using the image enhancement model selection operation 250 and an obtain model function 316.

In some cases, the image enhancement model selection operation 250 may select one or more of an exponential model 318, an adaptive gamma correction model 320, and an adaptive affine correction model 322 based on the output(s) from the light condition evaluation operation 240. This allows the image enhancement model selection operation 250 to determine which of a set of predefined image enhancement models will be applied to enhance the image frame 202, and the obtain model function 316 can output the selected model(s).

The estimation operation 260 can include a parameter determination function 324, which generally operates to determine one or more parameters for the selected image enhancement model(s). For example, an estimation of exponential model parameters function 326 can be used to estimate parameters for the exponential model 318, such as by identifying one or more camera parameters and an exposure ratio map. An estimation of adaptive gamma correction model parameters function 328 can be used to estimate parameters for the adaptive gamma correction model 320, such as by identifying a gamma coefficient for gamma correction. An estimation of adaptive affine correction model parameters operation can be used to estimate parameters for the adaptive affine correction model 322, such as by identifying a gain and a bias. The parameter determination function 324 can obtain and output the identified parameter(s) to the integration operation 270.

The integration operation 270 can include an integrating parameters with camera model function 332, which generally operates to integrate the determined parameter(s) with a selected camera model. An integrating camera model with image enhancement model function 334 generally operates to integrate the resulting camera model with the selected image enhancement model. An optimization function 336 generally operates to optimize the resulting integrated image enhancement model. The visual quality enhancement operation 280 can include an enhancing image frame with image enhancement model function 338, which generally operates to apply the integrated image enhancement model to one or more image frames 202, thereby producing one or more enhanced image frames. A verification function 340 generally operates to verify the enhanced image frames, such as by ensuring that the enhanced image frames have adequate visual quality. A finalization function 342 generally operates to finalize the enhanced image frames, such as by applying any final post-processing.

Although FIG. 3 illustrates another example of a process 300 for generating enhanced output image frames through integration of image enhancement models, various changes may be made to FIG. 3. For example, various operations or functions in FIG. 3 may be combined, further subdivided, replicated, omitted, or rearranged and additional components or functions may be added according to particular needs.

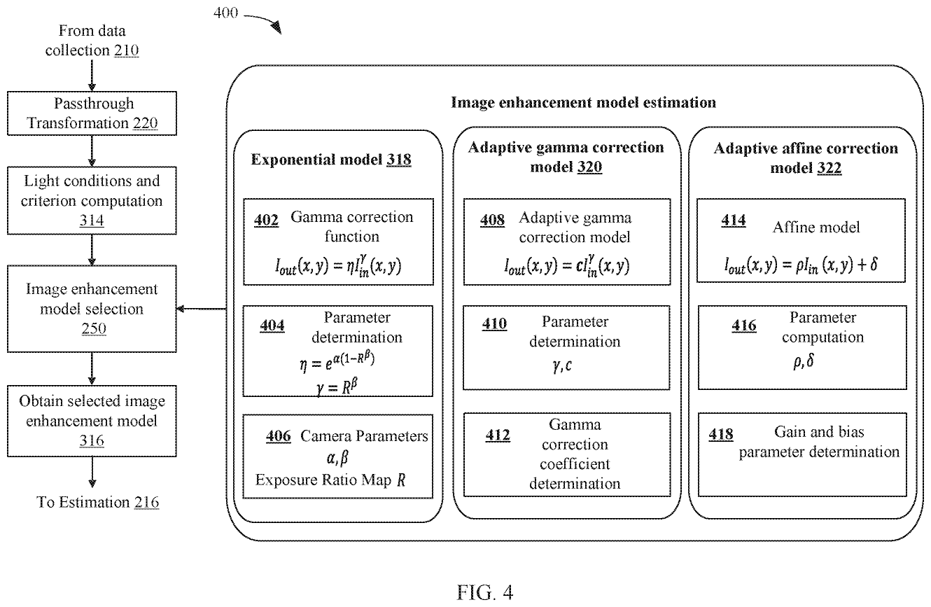

FIG. 4 illustrates an example process 400 for estimating an image enhancement model to be applied to an input image frame in accordance with this disclosure. The process 400 could, for example, be performed as at least part of the image enhancement model selection operation 250 or the image enhancement model generation function 315. For ease of explanation, the process 400 shown in FIG. 4 is described as being performed using the electronic device 101 shown in FIG. 1. However, the process 400 shown in FIG. 4 may be performed using any other suitable device(s) (such as the server 106) and in any other suitable system(s).

As shown in FIG. 4, different types of image enhancement models may be selected for use. For example, an exponential model 318 (also referred to as an exponential image enhancement model) can be selected and estimated by the image enhancement model selection operation 250 according to a camera response function (CRF) and one or more imaging sensor properties. In some cases, the camera response function can be defined as follows.

$$I ( x , y ) = f ( E ( x , y ) )$$

Here, I(x, y) represents an image frame, which may be a color image frame (such as an image frame 202 or transformed version thereof). Also, E(x, y) represents irradiance measured as power per unit area incident on a surface point as measured by an imaging sensor 180. In addition, f(⋅) represents a camera response function that defines how the image frame 202 is generated based on the irradiance and depends on one or more imaging sensor properties.

In order to estimate or determine the camera response function, a brightness transformation function (BTF) can be employed. The brightness transformation function corresponds to the effects of lighting conditions present in a subject scene captured by the imaging sensor 180. In some cases, the brightness transformation function can be defined as follows.

$${I}_{exp 1} ( x , y ) = g ( {I}_{exp 0} , k )$$

Here, Iₑₓₚ₁(x, y) represents an image frame created with one camera exposure, Iₑₓₚ₀(x, y) represents an image frame generated with another camera exposure, k represents an exposure ratio, and g(⋅) represents the brightness transformation function. The brightness transformation function describes the relationship between two image frames that are created with two different exposures of the imaging sensor 180.

In some embodiments, a gamma correction function 402 can be used to estimate the camera response function. In some cases, the gamma correction function 402 can support correction function defined in the following manner.

$${I}_{exp 1} ( x , y ) = η {I}_{exp 0}^{γ} ( x , y )$$

Here, η and γ are parameters that can depend on camera properties and an exposure ratio and can be determined using a parameter determination function 404. In some cases, the parameter determination function 404 may determine these parameters in the following manner.

$$\{ \begin{matrix}η = {e}^{α ( 1 - {R}^{β} )} \\ γ = {R}^{β}\end{matrix}$$

A camera parameters and exposure map determination function 406 can be used to determine or apply α and β, which may represent imaging sensor properties, and an exposure ratio map R. In some embodiments, the imaging sensor properties α and β may be calibrated and/or predefined, such as during manufacture of the imaging sensor 180. In some cases, the camera parameters and exposure map determination function 406 may determine the exposure ratio map R using an algorithm that can quickly estimate the exposure ratio map R for an image frame based on the following.

$$\{ \begin{matrix}α = 1 + σ \\ β = - α / 4\end{matrix}$$

Here, σ is the standard deviation of the image frame Iₑₓₚ₀(x, y). A mean and standard deviation (μ, σ) of the image frame Iₑₓₚ₀(x, y) can be defined as follows.

$$\{ \begin{matrix}μ = \frac{1}{MN} {\sum }_{i = 0}^{N - 1} {\sum }_{j = 0}^{M - 1} {I}_{exp 0} ( x , y ) \\ σ = \sqrt{\frac{1}{MN} {\sum }_{i = 0}^{N - 1} {\sum }_{j = 0}^{M - 1} {( {I}_{exp 0} ( x , y ) - μ )}^{2}}\end{matrix}$$

Here, (M, N) is a size of the image frame. As described below, an imaging sensor 180 can be calibrated to obtain optimal values (αₒₚₜ>βₒₚₜ).

An adaptive gamma correction model 320 can also be selected and estimated by the image enhancement model selection operation 250. The adaptive gamma correction model 320 can be obtained by defining an initial adaptive gamma correction image enhancement model 408, which could be defined as follows.

$${I}_{out} ( x , y ) = {cI}_{in}^{γ} ( x , y )$$

Here, γ is a gamma correction coefficient that controls contrast of an image frame, and c is a coefficient that controls brightness of the image frame. In some cases, for an image frame with low contrast and high or adequate brightness, c=1. Accordingly, contrast may be enhanced while brightness can be fixed or otherwise remains constant. In some embodiments, with c=1, a logarithmic gamma correction coefficient can be employed by a parameter determination function 410. In some cases, the gamma correction coefficient can be expressed as follows.

$$γ = {f}_{γ1} ( σ )$$

Here, fᵣ₁(⋅) is a logarithmic function, and σ is a standard deviation of a luminance component of the image frame. The standard deviation σ can be defined as described above. Note, however, that other gamma correction coefficients may be employed, such as when γ>1. For an image frame with low contrast and low brightness, the coefficient c can be employed to control the brightness in the parameter determination function 410. In some cases, the brightness coefficient can be expressed as follows.

$$c = {f}_{c 1} ( γ , {I}_{in} ( x , y ) , μ )$$

Here, γ is the gamma correction coefficient, lᵢₙ(x, y) is an image frame, and u is a mean of a luminance component of the image frame. The mean μ can be defined as described above.

For an image frame with high or moderate contrast, an exponential gamma correction coefficient can be determined in a gamma correction coefficient determination function 412. In some cases, the gamma correction coefficient can be expressed as follows.

$$γ = {f}_{γ2} ( μ , σ )$$

Here, fᵣ₂(⋅) is an exponential function, u is a mean of a luminance component of the image frame, and σ is a standard deviation of the luminance component of the image frame. For an image frame with high contrast and low brightness, an exponential gamma correction coefficient can be defined as described above and can equal or exceed a value of one.

After enhancement of an image frame, such as by applying an integrated image enhancement model using the visual quality enhancement operation 280, brightness of the enhanced image frame may be increased, and visual quality can be improved compared to the original image frame. For an image frame with high contrast and high or adequate brightness, enhancement may not be desirable, required, or otherwise needed because the image frame may already possess good visual image quality.

In addition, an adaptive affine correction model 322 can be selected and estimated by the image enhancement model selection operation 250. The adaptive affine correction model 322 can be obtained by defining an initial adaptive affine correction image enhancement model or affine model 414, which could be defined as follows.

$${I}_{out} ( x , y ) = {ρ I}_{in} ( x , y ) + δ$$

Here, ρ represents gain, and δ represents bias. The parameters ρ and δ can be calculated using a parameter computation function 416, such as according to the one or more light conditions determined by the light condition determination operation 230 and evaluated by the light condition evaluation operation 240 and according to any enhancement requirement(s) for the image frame. The gain ρ and the bias δ an image frame can be adaptively calculated, such as by using the adaptive affine correction model parameters function 330, based on the light condition(s) that existed when the image frame 202 was captured by the sensor(s) 180.

In some cases, a histogram of an image frame 202 can be determined, such as by the using the light condition determination operation 230. Brightness and contrast can be controlled by optimizing the gain and bias values such that values in the resulting enhanced image frame generated by the visual quality enhancement operation 280 are within a predefined range, such as [0, 255]. For example, a histogram Hₕᵢₛₜ can be determined for a luminance component of a current image frame, such as a histogram Hₕᵢₛₜ defined as follows.

$${H}_{hist} = h ( {I}_{l} ( x , y ) , {N}_{bin} )$$

Here, I₁(x, y) represents the luminance component of the current image frame, and N_{bin} represents a quantity or number of bins used while determining the histogram. The optimization function 336 can determine a cumulative distribution of the histogram in order to identify where color frequency is less than or otherwise fails to meet a specified threshold. The cumulative distribution H_{cum} of the histogram Hₕᵢₛₜ could be defined as follows.

$${H}_{cum} = {h}_{cum} ( {H}_{hist} ( i ) )$$

Here, i=0, 1, . . . , Nₕᵢₛₜ, and Nₕᵢₛₜ is the size of the histogram. A low end and a high end of the cumulative distribution, which can respectively be a left end and a right end of the histogram, can be cut or otherwise ignored to create a range with a minimum and a maximum. A pixel value range can be determined using a threshold for the cumulative distribution H_{cum}. The gain and/or bias parameter(s) can be determined for the image frame based on this range using a gain and bias parameter determination function 418, which can adaptively fit the parameter(s) to the camera and lighting environment.

Although FIG. 4 illustrates one example of a process 400 for estimating an image enhancement model to be applied to an input image frame, various changes may be made to FIG. 4. For example, various operations or functions in FIG. 4 may be combined, further subdivided, replicated, omitted, or rearranged and additional components or functions may be added according to particular needs.

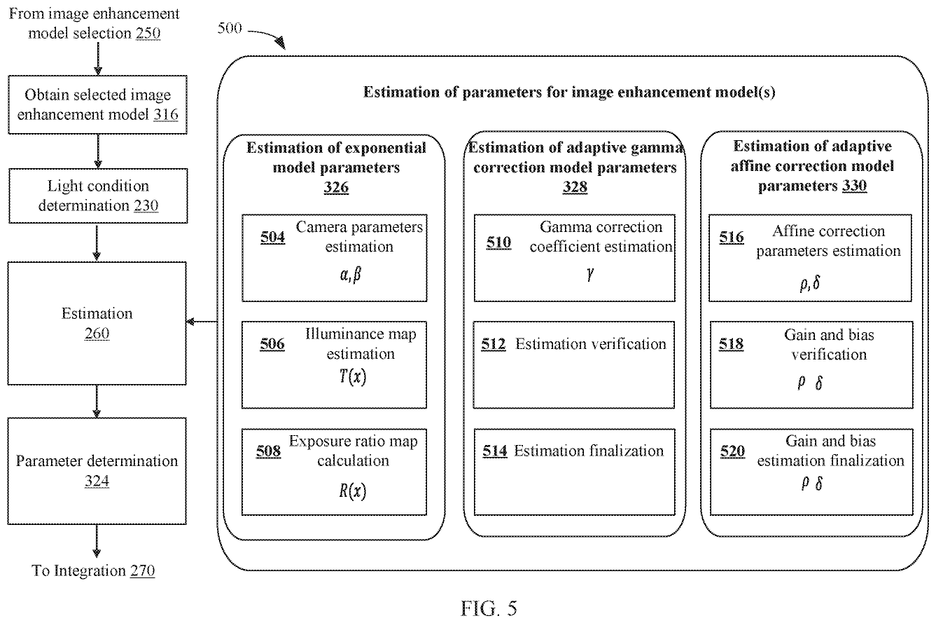

FIG. 5 illustrates an example process 500 for estimating parameters for use with an image enhancement model in accordance with this disclosure. The process 500 could, for example, be performed as at least part of the estimation operation 260. For ease of explanation, the process 500 shown in FIG. 5 is described as being performed using the electronic device 101 shown in FIG. 1. However, the process 500 shown in FIG. 5 may be performed using any other suitable device(s) (such as the server 106) and in any other suitable system(s).

As shown in FIG. 5, parameters and other information for different types of models can be determined. For example, when an adaptive exponential image enhancement model is selected, a camera parameter estimation function 504 can estimate one or more exponential model parameters, such as camera parameters a, β (also referred to as imaging sensor parameters), based on one or more imaging sensor properties using the estimation of exponential model parameters function 326. These camera parameters a, β could be employed to estimate an illumination map T(x) using an illuminance map estimation function 506 based on one or more determined and evaluated light conditions. For example, the illumination map T(x) could be determined using a linear solver to optimize the following minimization problem.

$${min}_{T} {\sum }_{x} ( {( T ( x ) - L ( x ) )}^{2} + λ g ( x ) )$$

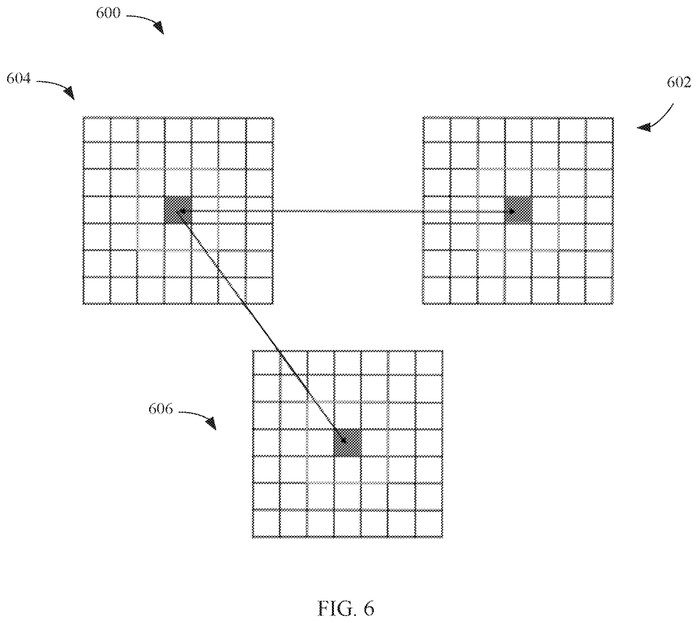

For instance, the linear solver could perform an iterative process, such as by using a gradient solver, to solve the minimization problem. Unfortunately, existing iterative processes can be slow and can incur high computational costs. This often introduces additional undesirable latency in existing image processing pipelines. In accordance with features of this disclosure, an improved illumination map calculation can be optimized using a process that incurs fewer computational costs than the existing iterative processes, which is described below with respect to FIG. 6. An exposure ratio map R(x) can be calculated by employing the illumination map T(x) with an exposure ratio map calculation function 508. For example, the exposure ratio map calculation function 508 can be used to calculate the exposure ratio map R(x) based on the illumination map T(x), where the exposure ratio map R(x) can be defined as follows.

$$R ( x ) = \frac{1}{max ( T ( x ) , ε )}$$

Here, ε is a small number.

When an adaptive gamma correction image enhancement model is selected, a gamma correction coefficient estimation function 510 can be used to estimate a gamma correction coefficient γ. The gamma correction coefficient γ can be verified using an estimation verification function 512 and finalized using an estimation finalization function 514, such as based on one or more imaging sensor properties and one or more determined and evaluated light conditions.

When the adaptive affine correction image enhancement model is selected, an affine correction parameters estimation function 516 can be used to estimate affine correction parameters for gain and bias ρ, δ. The affine correction parameters for gain ρ and bias δ can be adaptively estimated for an image frame, such as an image frame 202, using the affine correction parameters estimation function 516. For example, a gain range of the image frame can be defined as [p_{lower}, pᵤₚₚₑᵣ]. Accordingly, a gain p of the image frame could be defined as follows.

$$ρ = \frac{255}{{p}_{upper} - {p}_{lower}}$$

A bias δ of the image frame can be defined as follows.

$$δ = - {p}_{lower} ρ$$

The affine correction parameters for gain and bias ρ, δ can be verified using a gain and bias verification function 518 and finalized using a gain and bias estimation finalization function 520 based on one or more imaging sensor properties and one or more determined and evaluated light conditions. Accordingly, based on the estimated gain and bias parameters [ρ, δ], contrast and brightness of the image frame 202 can be integrated with the selected image enhancement model from the image enhancement model selection operation 250 by the integration operation 270.

Although FIG. 5 illustrates one example of a process 500 for estimating parameters for use with an image enhancement model, various changes may be made to FIG. 5. For example, various operations or functions in FIG. 5 may be combined, further subdivided, replicated, omitted, or rearranged and additional components or functions may be added according to particular needs.

FIG. 6 illustrates an example process 600 for optimizing an illumination map in accordance with this disclosure. The process 600 could, for example, be performed as at least part of the illuminance map estimation function 506. For ease of explanation, the process 600 shown in FIG. 6 is described as being performed using the electronic device 101 shown in FIG. 1. However, the process 600 shown in FIG. 6 may be performed using any other suitable device(s) (such as the server 106) and in any other suitable system(s).

As shown in FIG. 6, information from an image frame/(x) 602, which can be an image frame 202, can be used to filter an illumination map T(x) 604 and thereby generate an optimized illumination map \hat{T} (x). For example, the illumination map T(x) 604 can be generated based on an estimated illumination L (x) by applying a guidance function to information from the image frame I (x) 602. Initially, the filter transfers a structure of the image frame I(x) 602 to the illumination map T(x) 604. The illumination map T(x) 604 can be defined as a linear combination of the estimated illumination L (x). An illumination value of the structure can be determined based on the estimated illumination L (x) and guidance information. In some cases, the guidance function can be defined as follows.

$$g ( x ) = {\sum }_{d ∈ \{ h , v \}} \frac{{( {∇}_{d} T ( x ) )}^{2}}{{\vert {∇}_{d} L ( x ) \vert}^{2} + ε}$$

Here, ε is a small number. The optimized illumination map \hat{T} (x) 606 can be determined according to the filtering process.

In some embodiments, multiple image enhancement models can be selected by the image enhancement model selection operation 250 for image frame enhancement. Based on one or more light conditions determined by the light condition determination operation 230 and evaluated by the light condition evaluation operation 240, the image enhancement models can be integrated by the integration operation 270 and used for enhancing an image frame by the visual quality enhancement operation 280. Here, estimating parameters by the estimation operation 260 for an exponential model selected by the image enhancement model selection operation 250 could be accelerated compared to existing techniques. For example, an illumination map can be determined by the estimation operation 260 using the process 600 (by transferring a structure of an image frame I(x) 602 to an illumination map T(x) 604).

In some embodiments that use an integrated collection of image enhancement models, an illumination map T(x) 604 can be determined with a linear solver, such as one that uses a conjugate gradient method, supporting an iterative process to compute an optimal solution for a minimization problem. After obtaining the illumination map, an exposure ratio map R can be determined for each of the plurality of selected image enhancement models, which can be integrated by the integration operation 270. The exposure ratio map R can be determined by establishing a mapping of intensity values between image frames having different exposure levels.

Although FIG. 6 illustrates one example of a process 600 for optimizing an illumination map, various changes may be made to FIG. 6. For example, various operations or functions in FIG. 6 may be combined, further subdivided, replicated, omitted, or rearranged and additional components or functions may be added according to particular needs.

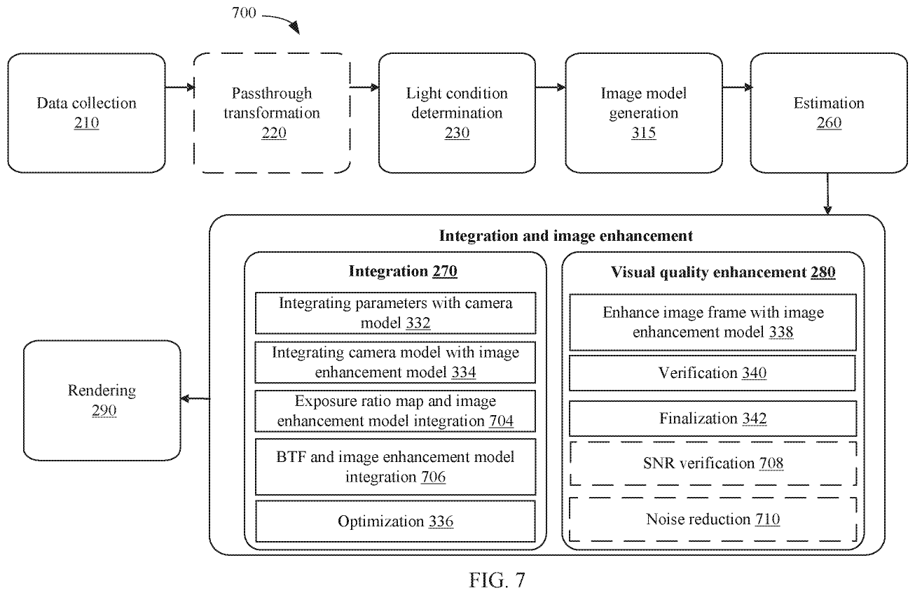

FIG. 7 illustrates an example process 700 for enhancing an input image frame using an integrated image enhancement model in accordance with this disclosure. The process 700 could, for example, be performed as at least part of the integration operation 270 and as at least part of the visual quality enhancement operation 280. For ease of explanation, the process 700 shown in FIG. 7 is described as being performed using the electronic device 101 shown in FIG. 1. However, the process 700 shown in FIG. 7 may be performed using any other suitable device(s) (such as the server 106) and in any other suitable system(s).

As shown in FIG. 7, the integration operation 270 can include the integrating parameters with camera model function 332, which can be used (when an exponential model 318 is selected) to integrate the result of the exposure map determination function 406 with the camera model. The integration operation 270 can also include the integrating camera model with image enhancement model function 334, which can integrate the resulting camera model with a selected image enhancement model.

The integration operation 270 can further include an exposure ratio map and image enhancement model integration operation 704 and a BTF and image enhancement model integration operation 706. The exposure ratio map and image enhancement model integration operation 704 can be used when an exponential model 318 is selected in order to integrate the exposure map output of the camera parameters and exposure map determination function 406 with the exponential model 318. The BTF and image enhancement model integration operation 706 can use the output of the exposure ratio map and image enhancement model integration operation 704 to integrate a brightness transform function with the exponential model 318. In addition, the integration operation 270 can include the optimization function 336, which can optimize the integrated enhancement model with estimated parameters according to the criteria from the light condition determination operation 230.

The visual quality enhancement operation 280 can include the enhance image frame with image enhancement model function 338, which can apply the selected image enhancement model (such as the exponential model 318, adaptive gamma correction model 320, and/or adaptive affine correction model 322) to at least one image frame 202 or transformed version thereof. The visual quality enhancement operation 280 can also include the verification function 340, which can verify the enhanced image frame(s) with one or more image quality parameters (such as the light conditions criteria from the light condition determination operation 230) to determine if each enhanced image frame is acceptable. If not, another image enhancement model may be applied. The visual quality enhancement operation 280 can further include the finalization function 342, which can finalize each enhanced image frame according to the verification result for color consistency with global enhancement.

In some embodiments, the visual quality enhancement operation 280 may include an SNR verification operation 708 and a noise reduction operation 710. For example, the SNR verification operation 708 could compare the SNR of each verified and finalized enhanced image frame with one or more thresholds and/or ranges to determine if the SNR is acceptable (such as above a minimum threshold or within an acceptability range). If the SNR is acceptable, the verified and finalized enhanced image frame could undergo rendering by the rendering operation 290. If not, the verified and finalized enhanced image frame could undergo noise reduction. The noise reduction operation 710 generally operates to reduce noise in verified and finalized enhanced image frames. The noise reduction operation 710 could use any suitable noise reduction or filtering technique(s), such as frame averaging or filtering, to reduce noise in image frames. Denoised image frames generated by the noise reduction operation 710 can undergo rendering by the rendering operation 290.

Although FIG. 7 illustrates one example of a process 700 for enhancing an input image frame using an integrated image enhancement model, various changes may be made to FIG. 7. For example, various operations or functions in FIG. 7 may be combined, further subdivided, replicated, omitted, or rearranged and additional components or functions may be added according to particular needs.

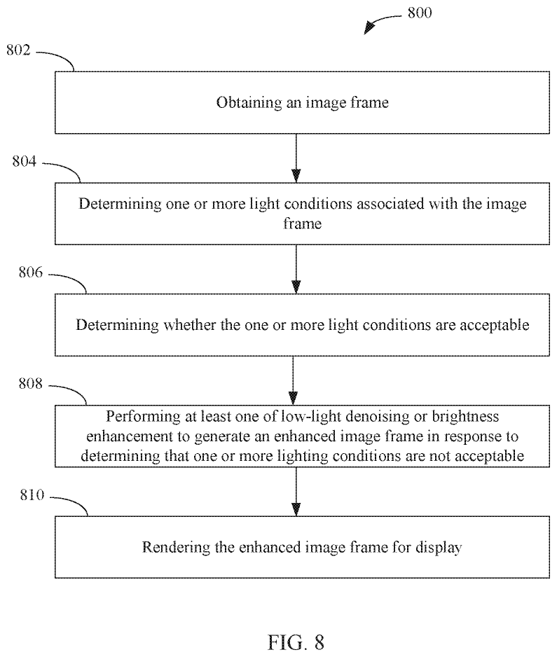

FIG. 8 illustrates an example method 800 for integration of image enhancement models for XR or other applications in accordance with this disclosure. For ease of explanation, the method 800 shown in FIG. 8 is described as being performed using the electronic device 101 shown in FIG. 1. However, the method 800 shown in FIG. 8 may be performed using any other suitable device(s) (such as the server 106) and in any other suitable system(s).

As shown in FIG. 8, an image frame is obtained at step 802. This may include, for example, the at least one processor 120 of the electronic device 101 performing the data collection operation 210 (possibly with the obtain image frame function 302) to obtain an image frame 202. One or more light conditions associated with the image frame are determined at step 804. This may include, for example, the at least one processor 120 of the electronic device 101 performing the light condition determination operation 230 to determine one or more light conditions associated with the image frame 202, such as brightness and/or contrast. This may also include the at least one processor 120 of the electronic device 101 performing the light condition determination operation 230 to determine one or more criteria associated with the image frame 202.

A determination is made whether the one or more light conditions are acceptable at step 806. This may include, for example, the at least one processor 120 of the electronic device 101 performing the light condition evaluation operation 240 to determine whether the one or more light conditions associated with the image frame 202 are acceptable based on one or more criteria, such as by comparing the one or more light conditions to one or more thresholds.

In response to determining that the one or more light conditions are not acceptable, low-light denoising and/or brightness enhancement can be performed on the image frame to generate an enhanced image frame at step 808. This may include, for example, the at least one processor 120 of the electronic device 101 implementing the visual quality enhancement operation 280, such as to perform low-light denoising using the noise reduction operation 710 and/or brightness enhancement using the enhance image frame with image enhancement model function 338 to generate an enhanced image frame. At step 810, the enhanced image frame can be rendered for display. This may include, for example, the at least one processor 120 of the electronic device 101 performing the rendering operation 290 to render the enhanced image frame and generate the output image frame 292.

Although FIG. 8 illustrates one example of a method 800 for integration of image enhancement models for XR or other applications, various changes may be made to FIG. 8. For example, while shown as a series of steps, various steps could overlap, occur in parallel, occur in a different order, or occur any number of times (including zero times).

It should be noted that the functions shown in or described with respect to the figures can be implemented in an electronic device 101 or other device(s) in any suitable manner. For example, in some embodiments, at least some of the functions shown in or described with respect to the figures can be implemented or supported using one or more software applications or other software instructions that are executed by the processor 120 of the electronic device 101 or other device(s). In other embodiments, at least some of the operations shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices in various embodiments.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an image frame;
determining, using the at least one processing device, one or more light conditions associated with the image frame;
determining, using the at least one processing device, whether the one or more light conditions are acceptable;
performing, using the at least one processing device, at least one of low-light denoising or brightness enhancement to generate an enhanced image frame in response to determining that the one or more light conditions are not acceptable; and
rendering, using the at least one processing device, the enhanced image frame for display.

2. The method of claim 1, further comprising:
performing a passthrough transformation of the image frame to generate a transformed image frame; and
rendering the transformed image frame for display in response to determining that the one or more light conditions are acceptable;
wherein at least one of the low-light denoising or the brightness enhancement is performed using the transformed image frame in response to determining that the one or more light conditions are not acceptable.

3. The method of claim 1, wherein performing at least one of the low-light denoising or the brightness enhancement comprises:
selecting at least one image enhancement model;
determining at least one parameter for the at least one image enhancement model;
integrating the at least one image enhancement model with the at least one parameter to generate at least one integrated image enhancement model; and
performing low-light enhancement using the at least one integrated image enhancement model.

4. The method of claim 3, wherein selecting the at least one image enhancement model comprises selecting at least one of:
an exponential image enhancement model and exposure ratio map for local image enhancement;
an adaptive gamma correction model with a gamma coefficient for global image enhancement; or
an adaptive affine correction model with gain and bias parameters for global image enhancement.

5. The method of claim 4, further comprising:
in response to selection of two or more of the image enhancement models, integrating the two or more image enhancement models.

6. The method of claim 3, wherein the at least one parameter comprises at least one of: multiple camera parameters, a gamma coefficient for gamma correction, or a gain and a bias for an affine correction.

7. The method of claim 3, wherein integrating the at least one image enhancement model with the at least one parameter comprises:
integrating the at least one parameter with a camera model to generate an estimated camera model;
integrating the estimated camera model with the at least one image enhancement model to generate the at least one integrated image enhancement model; and
optimizing the at least one integrated image enhancement model.

8. An electronic device comprising:
at least one processing device configured to:
obtain an image frame;
determine one or more light conditions associated with the image frame;
determine whether the one or more light conditions are acceptable;
perform at least one of low-light denoising or brightness enhancement to generate an enhanced image frame in response to determining that the one or more light conditions are not acceptable; and
render the enhanced image frame for display.

9. The electronic device of claim 8, wherein the at least one processing device is further configured to:
perform a passthrough transformation of the image frame to generate a transformed image frame; and
render the transformed image frame for display in response to determining that the one or more light conditions are acceptable;
wherein the at least one processing device is configured to perform at least one of the low-light denoising or the brightness enhancement using the transformed image frame in response to determining that the one or more light conditions are not acceptable.

10. The electronic device of claim 8, wherein, to perform at least one of the low-light denoising or the brightness enhancement, the at least one processing device is configured to:
select at least one image enhancement model;
determine at least one parameter for the at least one image enhancement model;
integrate the at least one image enhancement model with the at least one parameter to generate at least one integrated image enhancement model; and
perform low-light enhancement using the at least one integrated image enhancement model.

11. The electronic device of claim 10, wherein, to select the at least one image enhancement model, the at least one processing device is configured to select at least one of:
an exponential image enhancement model and exposure ratio map for local image enhancement;
an adaptive gamma correction model with a gamma coefficient for global image enhancement; or
an adaptive affine correction model with gain and bias parameters for global image enhancement.

12. The electronic device of claim 11, wherein the at least one processing device is further configured, in response to selection of two or more of the image enhancement models, to integrate the two or more image enhancement models.

13. The electronic device of claim 10, wherein the at least one parameter comprises at least one of: multiple camera parameters, a gamma coefficient for gamma correction, or a gain and a bias for an affine correction.

14. The electronic device of claim 10, wherein, to integrate the at least one image enhancement model with the at least one parameter, the at least one processing device is configured to:
integrate the at least one parameter with a camera model to generate an estimated camera model;
integrate the estimated camera model with the at least one image enhancement model to generate the at least one integrated image enhancement model; and
optimize the at least one integrated image enhancement model.

15. A non-transitory machine readable medium containing instructions that when executed cause at least one processor of an electronic device to:
obtain an image frame;
determine one or more light conditions associated with the image frame;
determine whether the one or more light conditions are acceptable;
perform at least one of low-light denoising or brightness enhancement to generate an enhanced image frame in response to determining that the one or more light conditions are not acceptable; and
render the enhanced image frame for display.

16. The non-transitory machine readable medium of claim 15, further containing instructions that when executed cause the at least one processor to:
perform a passthrough transformation of the image frame to generate a transformed image frame; and
render the transformed image frame for display in response to determining that the one or more light conditions are acceptable;
wherein the instructions when executed cause the at least one processor to perform at least one of the low-light denoising or the brightness enhancement using the transformed image frame in response to determining that the one or more light conditions are not acceptable.

17. The non-transitory machine readable medium of claim 15, wherein the instructions that when executed cause the at least one processor to perform at least one of the low-light denoising or the brightness enhancement comprise:
instructions that when executed cause the at least one processor to:
select at least one image enhancement model;
determine at least one parameter for the at least one image enhancement model;
integrate the at least one image enhancement model with the at least one parameter to generate at least one integrated image enhancement model; and
perform low-light enhancement using the at least one integrated image enhancement model.

18. The non-transitory machine readable medium of claim 17, wherein the instructions that when executed cause the at least one processor to select the at least one image enhancement model comprise:
instructions that when executed cause the at least one processor to select at least one of:
an exponential image enhancement model and exposure ratio map for local image enhancement;
an adaptive gamma correction model with a gamma coefficient for global image enhancement; or
an adaptive affine correction model with gain and bias parameters for global image enhancement.

19. The non-transitory machine readable medium of claim 18, further containing instructions that when executed cause the at least one processor, in response to selection of two or more of the image enhancement models, to integrate the two or more image enhancement models.

20. The non-transitory machine readable medium of claim 17, wherein the instructions that when executed cause the at least one processor to integrate the at least one image enhancement model with the at least one parameter comprise:
instructions that when executed cause the at least one processor to:
integrate the at least one parameter with a camera model to generate an estimated camera model;
integrate the estimated camera model with the at least one image enhancement model to generate the at least one integrated image enhancement model; and
optimize the at least one integrated image enhancement model.
